(19) United States
(12) Patent Application Publication
(10) Pub. No.: US 2009/0277083 A1
(43) Pub. Date: Nov. 12, 2009

(54) Modular structural system suitable for trellis

(76) Inventor: Richard C. Barnes, Fort Wayne, IN (US)

Correspondence Address: LAW OFFICES OF BRIAN C. PAULS, 919 SOUTH HARRISON STREET, SUITE 320, FORT WAYNE, IN, 46802, US

(21) Appl. No.: 12/151,937

(22) Filed: May 10, 2008

(51) Int. Cl. A01G 17/06

(52) U.S. Cl. 47/46

(57) ABSTRACT

A modular structural system including a plurality of elongate structural members. The structural members are formed of a fiber-reinforced polymeric material and have a common cross sectional configuration with a circular outer perimeter and two oppositely disposed T-shaped grooves. A central opening is disposed between the first and second grooves. A reinforcement member can be positioned in the central opening for additional strength. Bracket members having first and second flanged edges. The flanged edges can be securely engaged with the T-shaped grooves disposed on the structural members to secure two of the structural members together at an angle. The system may be used as a trellis and wire stays securable in the T-shaped grooves and a pivot bracket are also disclosed. The wire stays include a base positionable in the T-shaped groove and a shaft that extends outwardly. The pivot bracket pivotally joins together two of the elongate structural members.

### BACKGROUND OF THE INVENTION

1. Field of the Invention

The present invention relates to modular structural systems and, more particularly, a modular structural system that is well-suited for use in constructing a trellis.

2. Description of the Related Art

Many commercially grown crops require or benefit from the use of trellis systems including many fruit-bearing bushes and vines and various structural trellis systems have been developed for use with such crops. The installation of such systems is often a labor intensive and, thus, an expensive endeavor. The known trellis systems may be specifically adapted for use with a particular crop or limited number of related crops. When the market for such specially adapted trellis systems is relatively small, the cost of such systems can be relatively high.

For many crops, the trellis systems must be reconfigured at the transitions between the winter and growing seasons. For example, the trellis system may be collapsed into a more compact shape or used to support a thermal blanket during the winter season to prevent or inhibit wind or weather damage to the plants. This seasonal reconfiguration of trellis systems can often be a quite labor intensive endeavor.

A modular structural system that is well suited for use as a trellis system and which can be relatively easily installed and reconfigured would be a beneficial addition to the art.

### SUMMARY OF THE INVENTION

The present invention provides a modular structural system that can be adapted for various purposes and is particularly well-suited for constructing trellis systems.

The invention comprises, in one form thereof, a modular structural system including a plurality of elongate structural members. Each of the plurality of members is formed of a fiber-reinforced polymeric material and defines a substantially common cross sectional configuration. The common cross sectional configuration has a substantially circular outer perimeter interrupted by first and second oppositely disposed substantially T-shaped grooves. A central opening is disposed between the first and second grooves. The system also includes at least one bracket member having first and second flanged edges disposed at an angle. The first flanged edge is securably engageable with one of the T-shaped grooves disposed on a first one of the plurality of elongate structural members and the second flanged edge is securably engageable with another one of the T-shaped grooves disposed on a second one of the plurality of elongate structural members whereby the first and second elongate structural members are securable together at an angle. A reinforcement member is insertable into the central opening of one of the plurality of elongate structural members.

The invention comprises, in another form thereof, a modular trellis system adapted for use with trellis wires. The system includes a plurality of elongate structural members wherein each of the plurality of members is formed of a fiber-reinforced polymeric material and defines a substantially common cross sectional configuration. The common cross sectional configuration has a substantially circular outer perimeter interrupted by first and second oppositely disposed substantially T-shaped grooves. The system also includes at least one bracket member having first and second flanged edges disposed at an angle. The first flanged edge is securably engageable with one of the T-shaped grooves disposed on a first one of the plurality of elongate structural members and the second flanged edge is securably engageable with another one of the T-shaped grooves disposed on a second one of the plurality of elongate structural members whereby the first and second elongate structural members are securable together at an angle. At least one wire stay is securably engageable with one of the T-shaped grooves at a selected position along the T-shaped groove. The trellis wires are releasably graspable by the wire stay.

In some embodiments of the modular trellis system, each of the substantially T-shaped grooves is defined by a base surface and oppositely disposed lips spaced from and overlaying an outer portion of the base surface and the first and second flanged edges of the at least one bracket each comprise a central stem and two oppositely disposed outwardly extending flanges. In such an embodiment, the at least one bracket may further include first and second threaded fasteners respectively associated with the first and second flanged edges wherein after insertion of the first and second flanged edges in a respective one of the T-shaped grooves, each of the first and second fasteners is biasingly coupleable with a respective one of the base surfaces to thereby bias the outwardly extending flanges into engagement with the overlaying lips.

The invention comprises, in still another form thereof, a modular trellis system adapted for use with trellis wires. The system includes a plurality of elongate structural members wherein each of the plurality of members is formed by a fiber-reinforced polymeric material and defines a substantially common cross sectional configuration. The common cross sectional configuration has at least one substantially T-shaped groove defined by a base surface and oppositely disposed lips spaced from and overlaying an outer portion of the base surface. At least one wire stay is provided and includes a base. The base is positionable within one of the T-shaped grooves and is engageable with the overlaying lips. A shaft projects from the base and extends outwardly of the T-shaped groove when the base is positioned within the groove. The shaft has a distal end that defines a wire slot. The slot forms an opening wherein one of the trellis wires is positionable in the slot by passing a midsection of the wire through the opening of the slot. A retaining member is securable on the shaft and the retaining member prevents the removal of a wire from the slot through the opening when the retaining member is secured on the shaft.

The invention comprises, in yet another form thereof, a trellis system having a plurality of pivotal trellis assemblies. Each of the pivotal trellis assemblies includes a first elongate structural member installable in a substantially vertical orientation; a second elongate structural member securable to the first structural member in a substantially horizontal orientation and a third elongate structural member pivotally secured to the second structural member with a pivot bracket assembly. The pivot bracket assembly includes a first pivot member pivotally securing the pivot bracket to the second structural member proximate an end of the second structural member and thereby defining a first pivot axis. A second pivot member pivotally secures the pivot bracket to the third structural member at a location spaced from and intermediate opposing first and second ends of the third structural member thereby defines a second pivot axis. The first and second pivot axes are substantially parallel and spaced apart wherein pivotal movement of the pivot bracket about the first pivot axis pivots the second pivot axis about the first pivot axis. Pivotal movement of the pivot bracket and the third structural member about the first and second pivot axes repositions the third structural member between a first orientation wherein the first end of the third structural member is positioned below the second structural member and proximate the first structural member and the second end of the third structural member projects upwardly of the second structural member and a second orientation wherein the third structural member is positioned substantially parallel with and proximate the second structural member.

### BRIEF DESCRIPTION OF THE DRAWINGS

The above mentioned and other features of this invention, and the manner of attaining them, will become more apparent and the invention itself will be better understood by reference to the following description of an embodiment of the invention taken in conjunction with the accompanying drawings, wherein:

FIG. 1 is a perspective view of a modular structural system assembled to form a trellis.

FIG. 2 is a perspective view of a modular structural system assembled to form another trellis.

FIG. 3 is a perspective view of a modular structural system assembled to form another trellis.

FIG. 4 is a perspective view of a wire stay mounted on a trellis assembly and holding a trellis wire.

FIG. 5 is a perspective view of a bracket member securing two elongate structural members together at an angle.

FIG. 6 is a side view of a wire stay.

FIG. 7 is a cross sectional view taken along line 7-7 of FIG. 8.

FIG. 8 is a top view of the wire stay of FIG. 6.

FIG. 9 is a side view of an end cap.

FIG. 10 is another side view of the end cap of FIG. 9.

FIG. 11 is a top view of the end cap of FIG. 9.

FIG. 12 is a side view of a 90 degree bracket member.

FIG. 13 is another side view of the bracket member of FIG. 12.

FIG. 14 is a top view of the bracket member of FIG. 12.

FIG. 15 is a cross sectional view taken along line 15-15 of FIG. 14.

FIG. 16 is a perspective view of the bracket member of FIG. 12.

FIG. 17 is a perspective view of a 135 degree bracket member.

FIG. 18 is a side view of the bracket member of FIG. 17.

FIG. 19 is another side view of the bracket member of FIG. 17.

FIG. 20 is a top view of the bracket member of FIG. 17.

FIG. 21 is a cross sectional view taken along line 21-21 of FIG. 20.

FIG. 22 is a cross sectional view of an elongate structural member having a reinforcement member inserted therein and a flexible retention strip and sheet material disposed in a T-shaped groove.

FIG. 23 is a detail view of a portion of FIG. 22.

FIG. 24 is perspective view of the end of an elongate structural member.

FIG. 25 is a perspective view of a pivot bracket assembly.

FIG. 26 is a perspective view of a trellis system utilizing pivot bracket assemblies.

FIG. 27 is side view of the trellis system of FIG. 26 in a first orientation.

FIG. 28 is a side view of the trellis system of FIG. 26 in a second orientation.

FIG. 29 is a perspective view of a trellis assembly having a flexible sheet material secured thereto.

FIG. 30 is a perspective view of a flexible sheet material secured to a structural member.

FIG. 31 is a perspective view of a footing assembly.

FIG. 32 is a perspective view of a fitting with sockets.

Corresponding reference characters indicate corresponding parts throughout the several views. Although the exemplification set out herein illustrates an embodiment of the invention, in one form, the embodiment disclosed below is not intended to be exhaustive or to be construed as limiting the scope of the invention to the precise form disclosed.

### DETAILED DESCRIPTION OF THE INVENTION

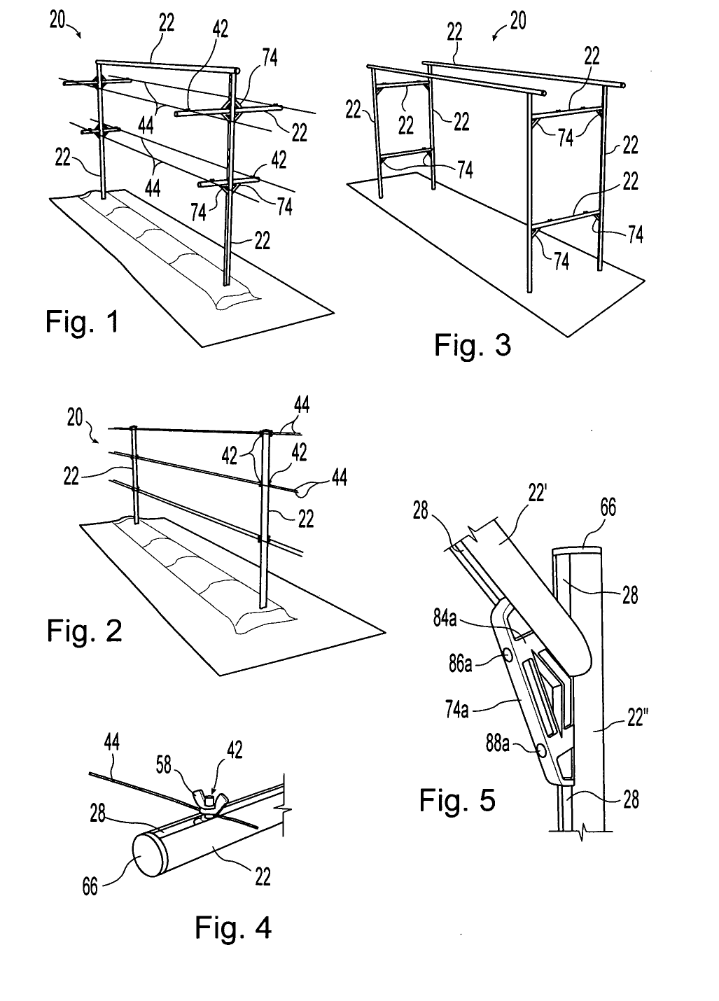

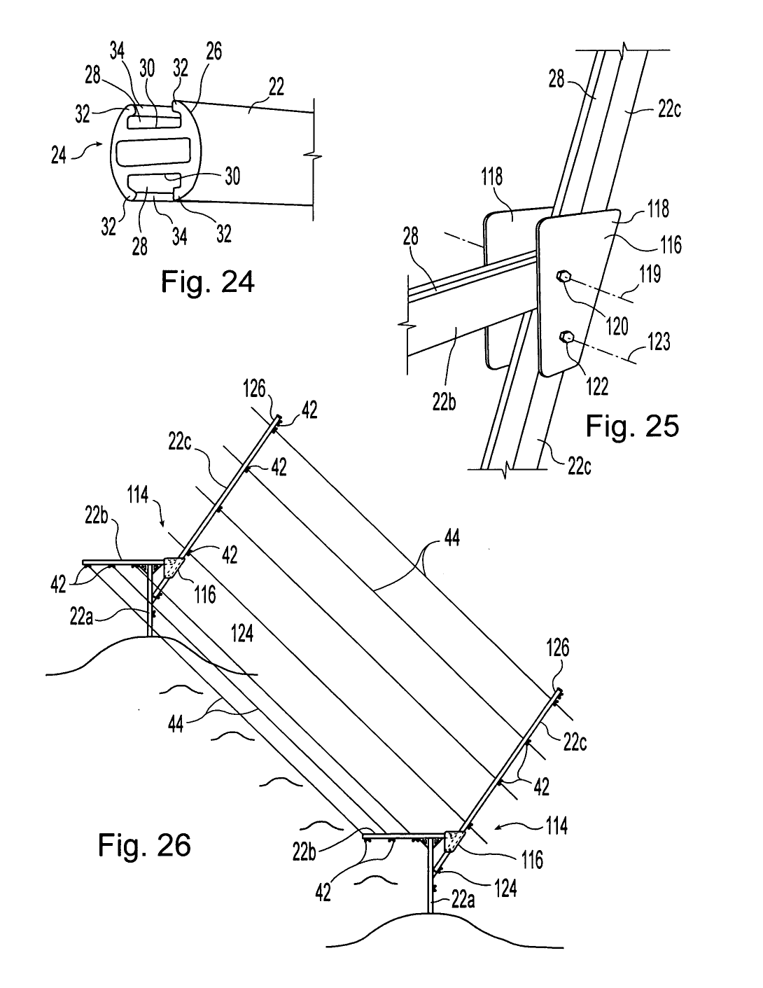

A modular system 20 in accordance with the present invention is depicted in FIGS. 1-3 in three different configurations. System 20 includes elongate structural members 22 which are formed out of a fiber-reinforced polymeric material. Structural members 22 have a common cross sectional configuration 24 which is best seen in FIGS. 22-24.

Cross sectional configuration 24 includes a substantially circular outside perimeter 26 that is interrupted by two diametrically oppositely disposed substantially T-shaped grooves 28. T-shaped grooves 28 include a base surface 30 and two oppositely disposed lips 32 that are spaced from and overlay base surface 30. Lips 32 project inwardly and define a groove opening 34. Located between the two T-shaped grooves 28 is a substantially rectangular central opening 36. In the illustrated embodiments, T-shaped grooves 28 and central opening 36 extend the full length of elongate members 22.

A reinforcement member 38 (FIG. 22) is insertable into central opening 36. In the illustrated embodiment, reinforcement member 38 is a 1 inch by ¼ inch hot rolled flat steel bar that is positioned within opening 36 such that it can be later removed from the structural member 22 without destroying either reinforcement member 38 or structural member 22. In alternative embodiments, however, reinforcement member 38 could be more securely fixed within structural member 22. For example, an adhesive could be used to secure reinforcement member 38 within opening 36 or holes could be drilled through structural member 22 and reinforcement member 38 and members 22, 38 secured together with nuts and bolts.

Different materials and processes may be used to form elongate structural members 22. The illustrated structural members are formed out of a polymeric material with reinforcing fibers using a pultrusion process. For example, the structural members may be, by volume, 80-85% fibers and 20-25% polyester resin which is a significantly higher fiber content than most fiber reinforced polymeric materials which are more typically have a 50% fiber 50% resin content. The relatively high fiber content of members 22 enhances their ability to hold tight tolerances and provides members 22 with greater thermal stability, i.e., members 22 are subject to relatively smaller dimensional changes due to a given change in temperature. Both of these features, i.e., the ability to hold tighter tolerances and thermal stability, enhance the ability of structural members 22 to function in a modular system where interchangeability is important. The thermal stability is particularly useful for systems that are installed in the outside environment and are subject to seasonal adjustments in both warm and cold weather. For example, some forms of trellis assemblies are subject to adjustments during either or both the winter and summer seasons.

For the cross sectional configuration of the illustrated embodiment, reinforcement fibers in the form of fiberglass rovings extending along the length of members 22 may be advantageously concentrated in the areas designated with reference numeral 40 in FIGS. 22 and 23. Fiberglass matting 41 may also be advantageously positioned along all surfaces of the structural member 22 as illustrated in FIG. 23. In this regard, it is noted that while fiberglass matting 41 is positioned along those surfaces of member 22 that define central opening 36 and T-shaped groove 28 as well as outer perimeter 26 in the illustrated embodiment, the use of such fiberglass matting 41 is particularly beneficial where it reinforces the surfaces which define lips 32. Conventional additives may also be employed with members 22 to provide them with resistance to UV degradation and thereby provide members 22 with greater durability in installations where they are subjected to sunlight.

It is anticipated that when trellis and other structural systems are constructed using a modular system in accordance with the present invention, the manufacturer of the system will ship individual component parts that have already been cut to the proper lengths and may be simply assembled in the field. However, by using materials that are strong, light weight and easily workable to form structural members 22, members 22 may be cut to length, have holes drilled therethrough and otherwise be custom shaped using conventional wood working tools commonly found on small construction sites to thereby facilitate adjustments to the initial design to account for site irregularities or other unforeseen issues or necessary adjustments during the assembly process.

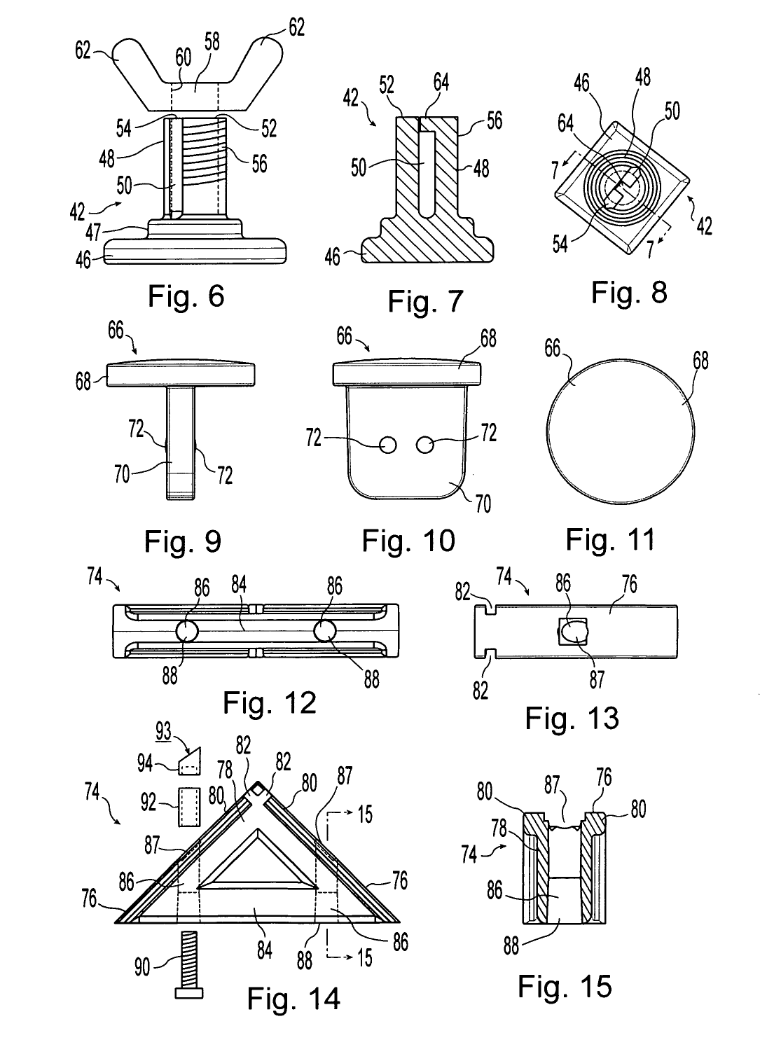

Wire stays 42 can be secured within T-shaped grooves 28 and be used to secure a trellis wire 44 to a structural member 22 as seen in FIG. 4. A wire stay 42 is shown in greater detail in FIGS. 6-8. Wire stay 42 includes a base 46 that can be positioned in T-shaped groove 28. A shaft 48 projects from base 46 and extends from groove opening 34 when base 46 is positioned within a groove 28. Shaft 48 forms a wire slot 50 and has a distal end 52 opposite base 46. Wire slot 50 is an open-ended slot forming a slot opening 52 on distal end 52 of shaft 48. A trellis wire 44 can be positioned in wire slot 50 by passing a midsection of trellis wire 44 through opening 52 of slot 50. Thus, unlike the threading of a needle, an end of wire 44 does not have to be threaded through slot 50. Although the illustrated wire stays 42 are sized to grasp 12 gauge wire or monofilament line (both of which are referred to as “wires” herein) which is a commonly used size for trellis wire, wire slot 50 may be given different dimensions to allow wire stay 42 to be used with differently sized wires or other thin objects.

A retaining member 58 is securable on shaft 48 to prevent the removal of wire 44 from slot 50. In the illustrated embodiment, shaft 48 has an externally threaded surface 56 which is engageable with a radially inward facing threaded surface 60 located on retaining member 58. In the illustrated embodiment threaded surface 56 is a molded rather than cut surface with MIO threads and retaining member 58 takes the form of a thumbscrew having outwardly projecting ears 62 which allow thumbscrew 58, and thus wire stay 42, to be manually installed and grasp a trellis wire 44 without the use of any tools. When thumbscrew 58 is tightened down against wire 44 located in slot 50, base 46 of wire stay 42 will be drawn into engagement with the underside of groove lips 32 and wire 44 will be grasped between thumbscrew 58 and the outer surface of structural member 22 within slot 50 to thereby secure wire 44 to the structural member 22. Shaft 48 of wire stay 42 also includes a shoulder 47 that is disposed adjacent base 46 and has an outer circumference that substantially fills groove opening 34 when wire stay 42 is mounted in groove 28.

When thumbscrew 58 is loose or removed, wire stays 42 can be easily slid along the length of the T-shaped groove 28 in which base 46 is positioned to locate the wire stay 42 at a desired position along the elongate member 22. The trellis wire 44 is passed through slot opening 50 (thumbscrew 58 must be removed from shaft 48 to avoid having to “thread” trellis wire 44 through slot 50) and then thumbscrew 58 is tightened to releasably grasp trellis wire 44 at the selected position along a structural member 22. The bottom of slot 50 is advantageously positioned on shaft 48 so that it will be located slightly within opening 34 of T-shaped groove 28 to thereby allow wire 44 to be grasped between thumbscrew 58 and member 22 rather than or in addition to being grasped between thumbscrew 58 and the bottom surface of slot 50.

In the illustrated embodiment, retaining members 58 are metal thumbscrews while wire stay 42 is an injection molded polymeric material. In this regard, it is noted that for modular systems 20 that will be used as a trellis system, the metal hardware components used in trellis system are all advantageously corrosion resistant and satisfy ASTM-B633. Similarly, the polymeric hardware such as wire stay 42, and end caps 66, brackets 74, 84 which are all discussed below, can be manufactured by injection molding fiberglass reinforced nylon with UV inhibitors. By manufacturing the polymeric hardware, e.g., wire stay 42, end caps 66, and brackets 74, 84, such that they have a relatively high degree of thermal stability and a thermal coefficient substantially similar to structural members 22, the ability to adjust such hardware on a trellis system during different seasons of the year is enhanced. Other suitable materials and manufacturing methods, however, may also be employed to form retaining members 58 and wire stays 42 and the other hardware disclosed herein. The illustrated wire stay 42 includes a spacing element 64 that is located proximate distal end 52 within slot opening 54. Spacing element 64 maintains the two opposing halves of shaft 48 that are separated by slot 50 at the proper distance. When passing trellis wire 44 through opening 54, the two halves of shaft 48 are biased outwardly to allow wire 44 to pass through opening 54 and past spacing element 64. Spacing element 64 helps to maintain the two shaft halves at the proper distance when securing thumbscrew 58 on shaft 48 but, more importantly, spacing element 64 helps to maintain the shaft halves at the proper distance when the polymeric material forming wire stay 42 is curing and thereby prevent the warping of shaft 48 during the curing process.

An end cap 66 is shown in FIGS. 9-11. FIG. 4 illustrates an end cap 66 installed on the end of a structural member 22. End cap 66 includes a cap member 68 and a insertion tab 70. Cap member 68 has a circular outer perimeter that generally conforms to the outer perimeter of structural members 22. Insertion tab 70 is inserted into the central opening 36 of a structural member 22 to thereby mount the end cap 66 on the end of a structural member 22. Insertion tab 70 has a thickness generally conforming to the interior dimensions of central opening 36. Insertion tab 70 also includes two small protrusions 72 on opposite sides of tab 70 so that the interference fit between tab 70 and central opening 36 will hold end cap 66 in place on structural member 22 without requiring any adhesives, fasteners or other additional securement features. Advantageously, the interference fit between tab 70 and opening 36 is not so large as to prevent the relatively easy removal of end cap 66 either by manually grasping the end cap 66 or by prying it off with a screw driver or other similar tool.

End cap 66 can be used for several different functions. When installing a structural member 22 as a vertical post in the ground, an end cap 66 can be positioned on the upper end of the structural member 22 and be struck by a hammer or other suitable tool to drive the lower end of structural member 22 into the ground. The use of an end cap 66 in this situation helps to more evenly distribute the force of the blows across the cross section of structural member 22 and thereby reduce the possibility that such blows will damage structural member 22. After a structural member 22 has been installed, the placement of an end cap on its exposed ends will inhibit the entry of water into central opening 36 which, unlike T-shaped grooves 28, is not open to the external environment along the length of structural member 22. By preventing water from entering central opening 36, the longevity of structural members 22 may be enhanced. This is particularly relevant in areas where water trapped within opening 36 would be subjected to freeze/thaw cycles. The installation of end caps 66 on the exposed ends of structural members 22 also serves an aesthetic purpose. Although modular structural system 20 will generally be used for quite utilitarian purposes such as constructing trellis systems, in many circumstances the appearance of such trellis systems can have an economic impact. For instance, many vineyards which utilize trellis systems also have tasting rooms at the location where the trellises are installed and having an aesthetically appealing trellis system could indirectly assist the sale of products on site.

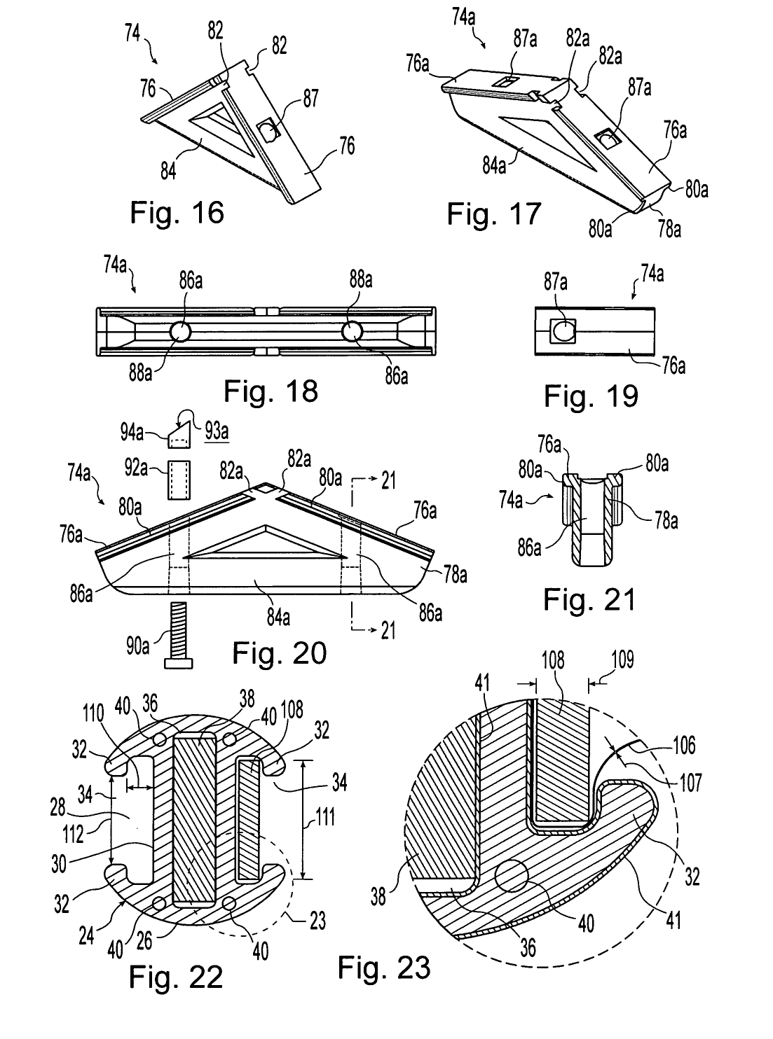

Elongate structural members 22 can be secured together at an angle using bracket members. Bracket member 74 is shown in FIGS. 12-16 and can be used to join two structural members 22 together at an angle of approximately 90 degrees. Bracket 74 has two flanged edges 76 which are disposed at an angle of approximately 90 degrees and which each have a cross section formed by a central stem 78 and two oppositely disposed outwardly extending flanges 80. Flanged edges 76 are each inserted into a T-shaped groove 28 on a structural member 22 when joining the structural members 22 together. Flanges 80 are positioned between base surface 30 and overlaying lips 32 with stem 78 projecting outwardly of groove 28 through groove opening 34. Near the intersection of flanged edges 76, each of the outwardly extending flanges 80 defines a gap 82 which allows for the passage of lips 32 when inserting the opposite flanged edge 76 into a T-shaped groove at the end of a structural member 22.

Bracket body 84 defines two openings 86 which each have one end 87 that opens on a flanged edge 76 and an opposite end 88 that faces outwardly and is accessible when bracket 74 is secured to two structural members 22. A fastener 90 extends through each opening 86 and is engaged with base surface 30 to engage flanges 80 with overlaying lips 32 and thereby secure flanged edge 76 in the T-shaped groove. In the illustrated embodiment, fastener 90 is a threaded fastener, e.g., a screw, that engages an internally threaded hollow metal sleeve 92 is located in opening 86. After positioning flanged edge 76 in a T-shaped groove 28 at the desired location, fastener 90 is turned so that the distal end of fastener 90 engages base surface 30 and biases flanges 80 into bearing contact with the underside of lips 32 and thereby secures the flanged edge 76 with the structural member 22.

The openings 86 of bracket 74 are arranged such that the axes of openings 86 are parallel with each other and with a line bisecting the angle formed by flanged edges 76. This arrangement allows for greater access to the outer end of openings 86 and facilitates the use of a tool, e.g., a screwdriver or wrench, when tightening fastener 90. In this regard, it is noted that the axes of openings 86, and the axes of fasteners 90 installed therein, are not positioned perpendicular to base surface 30. In some applications, it may be desirable to utilize a bearing plug 94 which is coupled to the distal end of fastener 90 at the inner end 87 of opening 86 and which has a bearing surface 93 that is oriented substantially parallel with base surface 30. When using such a bearing plug 94, as fastener 90 is inserted further into opening 86, bearing surface 93 would engage and bear upon base surface 30. The use of such a bearing plug 94 would distribute the bearing load imparted by fastener 90 over a greater surface area of base surface 30 than the bearing engagement of the distal tip of fastener 90 with base surface 30.

FIGS. 17-21 depict a bracket member 74a defining an angle of 135 degrees between its flanged edges 76a. Bracket member 74a is similar to bracket member 74 with the only difference being that flanged edges 76a of bracket member 74a define a 135 angle instead of a 90 degree angle. In this regard it is noted that by providing a bracket defining a 135 degree angle, a structural member 22 can be attached to a vertical member 22 that projects at a 45 degree angle relative to a horizontally extending line. Features associated with bracket member 74a and identified with reference numerals having an “a” as a suffix, e.g., 74a, are the same as the features described above with reference to bracket member 74 that utilize the same reference numeral. FIG. 5 illustrates bracket member 74a securing two structural members 22 together at a 135 degree angle. In FIG. 5, these two separate structural members have been identified as 22′ and 22″ to facilitate the discussion of bracket member 74a.

One end of the horizontally extending member 22′ has been cut to conform to the generally circular outer perimeter of the vertically oriented member 22″. Although the precise order of assembly is subject to some variation, when joining two structural members 22 together with bracket 74 or 74a, the bracket member 74, 74a, will often be positioned at a midpoint on one of the structural members, e.g., 22″ in FIG. 5, and near the end of the other structural member, e.g., 22′ in FIG. 5. In other instances, the bracket may be positioned near the ends of each of the structural members 22.

When joining together two structural members as shown in FIG. 5, it will generally be most efficient to first mount bracket member 74a on the structural member on which bracket 74a will be positioned at a midpoint, i.e., on the vertically oriented structural member 22″ in FIG. 5. Bracket 74a will be slid onto member 22″ by aligning a T-shaped groove 28 with flanged edge 76a of bracket 74a at one end of the structural member 22″ such that lips 32 of member 22″ are inserted through gaps 82a formed in the flanged edge 76a that will subsequently be used to engage the other structural member 22′. Bracket member 74a is then slid along structural member 22″ to its desired location and fastener 90a is tightened such that its distal end is biasingly engaged with base surface 30 and thereby engages flanges 80a with the underside of overlaying lips 32 of groove 28 and thereby secures bracket 74a to member 22″.

One end of the other structural member 22′ is then positioned at the projecting edge of the other flanged edge 76a of bracket 74a, one of the T-shaped grooves 28 of structural member 22′ is then aligned and slid into engagement with the flanged edge 76a until an end of structural member 22′ is butted up against the outer surface of vertically oriented member 22″. The horizontally oriented member 22′ is then secured by tightening a fastener 90a into a biasing engagement with the base surface 30 of member 22′. In this regard, it is noted that only one of the structural members, i.e., vertically oriented member 22″ of FIG. 5, has a portion thereof, i.e., lips 32, positioned in gaps 82a. It is further noted that bracket 74a is positioned at a location spaced from the ends of this member 22″ while it is positioned proximate one end of the other member 22′. It is further noted that the term “midpoint” is used herein simply to refer to an intermediate location between the ends wherein the bracket is spaced at least a small distance from that end such that it requires the entry of lips 32 into gaps 82 or 82a and is not limited to the one point located at equal distances from each of the two opposing ends.

Another optional feature of modular structural system 20 is the securement of a thin flexible sheet material 106 to a structural member 22 using a flexible retention strip 108. It is often desirable to place thin flexible sheet material over a trellis structure to provide various forms of protection for commercial crops. For example, in some locations and for some crops, it may be necessary or beneficial to place a thermal blanket formed out of non-woven polymeric fibers or similar thermal insulating material well known to those having ordinary skill in the art over the plants during cold weather. For other applications, such as fruit trees or berry producing bushes and brambles, it may be desirable to place a screen material over the plants that allows for the relatively uninhibited passage of air and moisture but which prevents birds and similar animals from gaining access to the plants and thereby prevents such birds and animals from feeding on the fruit or berries.

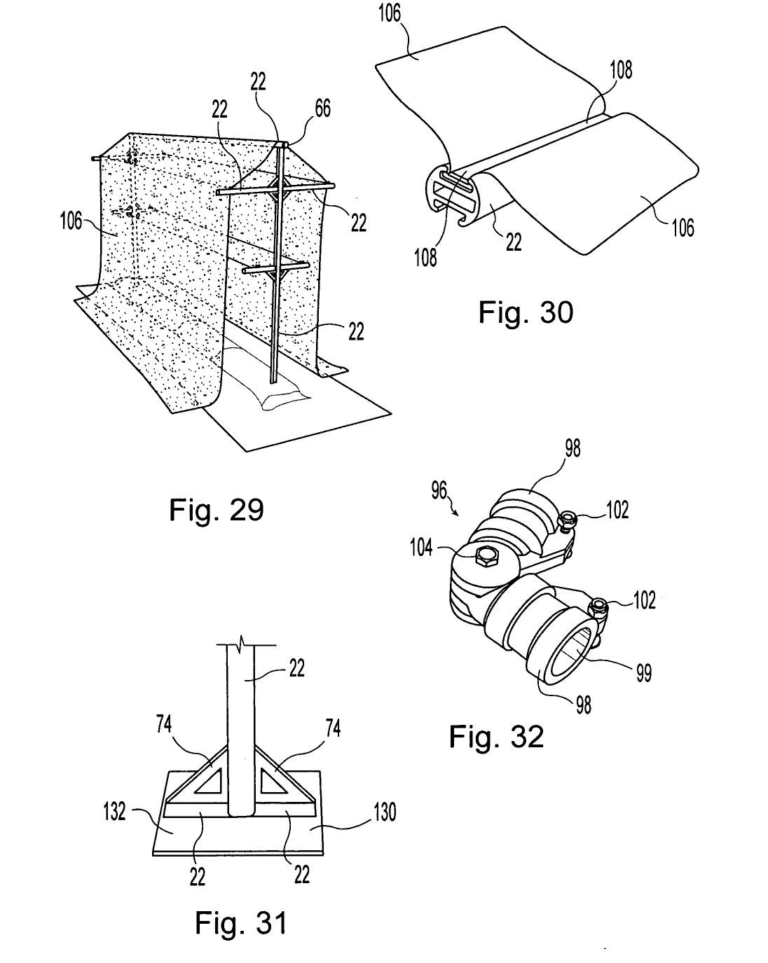

FIG. 29 depicts a trellis assembly 20 similar to that shown in FIG. 1 but with a thin flexible sheet material 106 secured thereto. Flexible sheet material 106 may take the form of a thermal insulating material, e.g., a 3 oz. fabric cover, a screen material or other suitable sheet material. As best understood with reference to FIGS. 22, 23 and 30, a thin flexible retention strip 108 is used to secure sheet material 106 to a structural member 22. The use of such strips 108 helps to retain sheet material 106 in place in the presence of wind and similar forces. To form the most secure attachment, retention strip 108 will extend the full length over which sheet material 106 is engaged with structural member 22 but more limited lengths of retention strips 108 may also be employed where appropriate.

Flexible retention strip 108 is positioned within a T-shaped groove 28 with flexible sheet material 106 positioned between retention member 108 and base surface 30 and overlaying lips 32 to thereby secure sheet material 106 to the structural member 22 by first placing flexible sheet material 106 over groove 28, aligning retention strip 108 with groove 28 on the opposite side of sheet material 106 and then pressing both flexible retention strip 108 and flexible sheet material 106 through opening 34 into groove 28 until both retention strip 108 and flexible sheet material 106 are seated within groove 28 below lips 32. To remove retention strip 108 and thereby detach sheet material 106 from structural member 22, it will generally be most convenient to slide strip 108 and sheet material 106 out of engagement groove 28 by sliding strip 108 and sheet material 106 out the end of structural member 22. Alternatively, strip 108 could be bent and pried outwardly through opening 34. In some circumstances, it might also be desired to attach sheet material 106 and strip 108 by sliding insertion into groove 28 at one end of the structural member 22. In yet other embodiments, strip 108 could be provided on one side with a projection along its centerline, similar to the dorsal fin of a shark, that would facilitate the removal of strip 108 without requiring the use of tools.

Retention strip 108 has a thickness 109 that is selected such that thickness 109 and twice the thickness 107 of flexible material 106 is slightly less than the distance 110 between base surface 30 and overlying lips 32 of groove 28. Retention strip 108 also has a width 111 that greater than the width 112 of groove opening 34 but which still allows strip 108 to be positioned within groove 28 with flexible material 106 wrapped around its opposite ends. In this manner, the seating of retention strip 108 within groove 28 with flexible sheet material 106 wrapped around strip 108 thereby secures flexible sheet material 106 to structural member 22. While similarly sized retention strips 108 should work with most flexible sheet materials 106, if a sheet material has a particularly large thickness, it may be necessary to adjust the dimensions of the retention strip 108 used with that particular sheet material. In the illustrated embodiment, flexible retention strip 108 is an extruded vinyl material having a 85 ShoreA durometer value. Strip 108 may be advantageously provided in long rolls that allow the end user to cut individual strips 108 to length to fit particular installations.

It can be advantageous to use trellises having rotatable cross arms when growing bramble fruit crops such as blackberry and raspberry crops. The use of such rotatable cross arm trellises facilitates the hand harvesting efficiency and winter protection of the plants. A plurality of trellis assemblies 114 having rotatable cross arms are depicted in FIG. 26. The trellis assemblies 114 depicted in FIG. 26 each have a pivot bracket assembly 116 and at least three structural members 22 which are labeled 22a, 22b, and 22c to facilitate discussion of the trellis assemblies. Structural members 22a are installed in the ground in a substantially vertical orientation. Structural members 22b are secured to vertical members 22a with two bracket members 74 and are disposed in a substantially horizontal orientation. A pivot bracket assembly 116 secures pivotal structural members 22c to the horizontal members 22b. Wire stays 42 are mounted on both the horizontal members 22b and the upper half of the pivotal members 22c located above pivotal assembly 116. Trellis wires 44 extend between trellis assemblies 114 and are attached thereto with the wire stays 42.

Pivot bracket assembly 116 is shown in FIG. 25 and includes two substantially bracket plates 118 which are located on opposite sides of the structural members 22b, 22c which are pivotally coupled by the pivot bracket assembly 116. Plates 118 may be formed out of a polymeric material similar to that used with the other hardware such as brackets 74 or out of other materials having a suitable strength and durability.

A first pivot member 120 is formed out of a nut and bolt assembly and pivotally secures bracket plates 118 on horizontal member 22b near one end of member 22b and defines a first pivot axis 119. A second pivot member 122 is also formed out of a nut and bolt assembly and pivotally secures bracket plates 118 with pivotal structural member 22c at a location that is spaced from and intermediate first and second ends 124, 126 and defines a second pivot axis 123. To pivotally secure bracket plates 118 with structural members 22b, 22c, holes are drilled through both the structural members 22b, 22c and bracket plates 118 and then first and second pivot members 120, 122 are installed in the aligned holes.

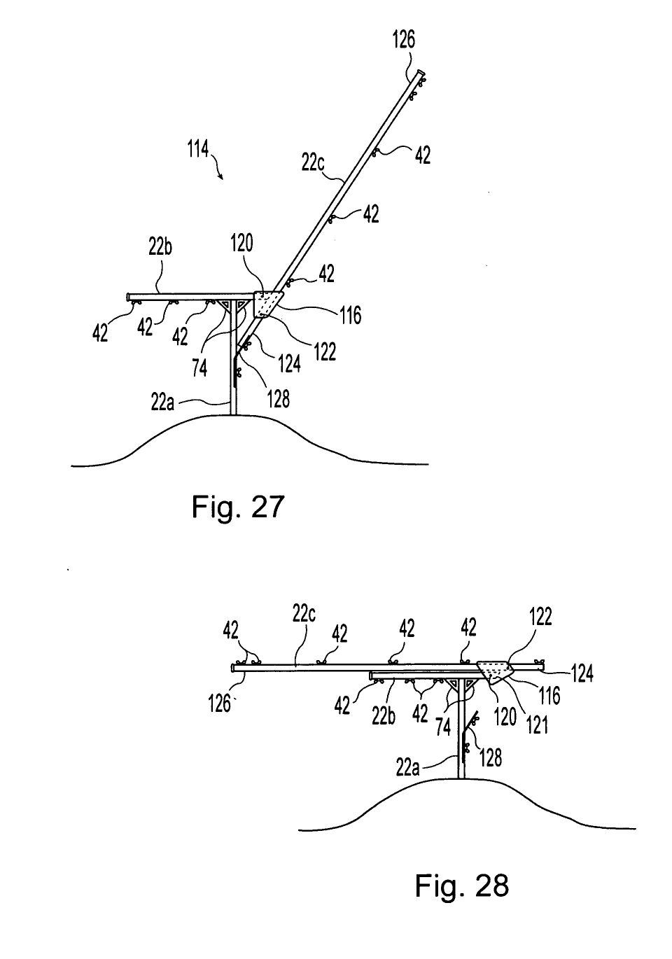

The first and second pivot axes 119, 123 are both substantially parallel and spaced apart. As a result, when bracket plates 118 are pivoted about first axis 119, the second pivot member 122 and second pivot axis 123 are pivoted through an arc between a position below horizontal member 22b (FIGS. 25-27) and a position above horizontal member 22b (FIG. 28). As best seen with reference to FIGS. 27 and 28, pivotal movement of bracket plates 118 about first pivot member 120 and pivotal movement of structural member 22c about second pivot member 122 repositions pivotal structural member 22c between a first orientation (FIG. 27) and a second orientation (FIG. 28).

In the first orientation (FIG. 27), first end 124 of pivotal structural member 22c is positioned below horizontal member 22b and proximate vertical member 22a with its second end 126 projecting upwardly of horizontal member 22b. In the illustrated embodiment, pivot member 122 is located closer to first end 124 than second end 126 such that when trellis assembly is in the configuration shown in FIG. 27, a majority of the length of pivotal structural member 22c projects above horizontal member 22b. A bent metal bracket 128 is secured to vertical member 22a by drilling holes through member 22a and bolting bracket 128 thereto. Pivotal structural member 122 is also provided with drilled holes near first end 124 which abuts metal bracket 128 when pivotal member 122 is in the orientation depicted in FIG. 27. Bolts are used to secure pivotal member 122 to metal bracket 128 and thereby releasably secure it in the position shown in FIG. 27. Various alternative methods of releasably securing pivotal member 122 in the position depicted in FIG. 27 may also be employed. It is also noted that the end of horizontal member 22b at which pivot bracket assembly 115 is attached can be advantageously cut an angle to correspond with the angle of pivotal member 22c when it is in the position shown in FIG. 27. Moreover, positioning pivot axes 120, 122 such that the angled end 121 of horizontal member 22b abuttingly engages pivotal structural member 22c when it is in the position shown in FIG. 27 further stabilizes member 22c when it is in the position shown in FIG. 27.

In the second orientation (FIG. 28), pivotal structural member 22c is positioned substantially parallel with and proximate horizontal member 22b. Pivotal structural member 22c is positioned in the same plane as horizontal member 22b and thus rests on top of horizontal member 22b. In practice, the bramble bush supported on trellis wires 44 located on members 22b, 22c will likely transfer some of the weight of member 22c and the plant material supported thereon to the lower portion of trellis assembly 114 by engagement with the plant material and trellis wires 44 that are directly supported by horizontal member 22b.

A fitting 96 having a pair of socket members 98 that define substantially cylindrical sockets 99 is depicted in FIG. 32. Socket members 98 are adapted to securely engage a radially outer surface 100 formed by the substantially circular outer perimeter 26 of cross sectional configuration 24 of structural members 22. By providing structural members 22 with a cross sectional configuration 24 having a substantially circular outer perimeter 26 and sizing the outer perimeter 26 so that it conforms with the size of conventional structural tubing, such as the steel tubing used to construct chain link fences and PVC piping, conventional fittings which are currently manufactured and intended for use with conventional structural tubing and PVC piping can be employed with structural members 22. For example, conventional fittings such as hinged fitting 96 are commonly sold at retail stores featuring home and building supplies. In the illustrated embodiment, members 22 have an outer perimeter 26 that has a radius similar to that of PVC piping with a nominal diameter of 1 inch.

Illustrated fitting 96 has two hinged socket members 98. After inserting the end of a structural member 22 into the open end of a socket 99, a threaded nut and bolt assembly 102 can be tightened to securely engage the socket member 98 with the structural member 22. Another threaded nut and bolt assembly 104 provides a pivot pin about which the two socket members 98 and any structural member 22 mounted therein can be pivoted. Tightening of nut and bolt assembly 104 will secure socket members 98 in a desired position. Fitting 96 could be used with a modular system 20 to form a pivotable gate or other pivoting structure or, by tightening nut and bolt assembly 104, to secure two structural members 22 together at a selected angle.

A footing assembly 130 is depicted in FIG. 31. For many applications employing a modular system 20, structural members 22 may be driven into the ground to provide a vertically oriented structural post or other known means for installing a post in the ground such as a tubular post receptacle mounted flush or below the ground surface or a helical post anchor. For some applications, mounting a structural member 22 in the ground to provide a vertically oriented member may not be desirable, e.g., a temporary installation, or it may not be feasible, e.g., a structural assembly set up within a building interior. In such situations, a footing assembly 130 can be placed on the ground or floor surface and have a structural member 22 attached thereto to provide a vertically oriented member 22 without extending below the ground surface. The illustrated footing assembly 130 includes a planar base plate member 132 having a pair of structural members 22 attached thereto with members 22 having bracket members 74 mounted thereon at a spacing that allows a structural member 22 to be secured to brackets 74. Members 22 securing brackets 74 to base plate 30 may be secured to base plate 130 in any appropriate manner, e.g., adhesives or fasteners, or the brackets 74 may be directly secured to base plate 130 or be integrally formed with base plate 130.

While this invention has been described as having an exemplary design, the present invention may be further modified within the spirit and scope of this disclosure. This application is therefore intended to cover any variations, uses, or adaptations of the invention using its general principles.

What is claimed is:

1. A modular structural system comprising:
a plurality of elongate structural members, each of said plurality of members being formed of a fiber-reinforced polymeric material and defining a substantially common cross sectional configuration, said common cross sectional configuration having a substantially circular outer perimeter interrupted by first and second oppositely disposed substantially T-shaped grooves and a central opening disposed between said first and second grooves;
at least one bracket member having first and second flanged edges disposed at an angle wherein said first flanged edge is securably engageable with one of said T-shaped grooves disposed on a first one of said plurality of elongate structural members and said second flanged edge is securably engageable with another one of said T-shaped grooves disposed on a second one of said plurality of elongate structural members whereby said first and second elongate structural members are securable together at an angle; and
a reinforcement member insertable into the central opening of one of said plurality of elongate structural members.

2. The modular structural system of claim 1 wherein each of said substantially T-shaped grooves is defined by a base surface and oppositely disposed lips spaced from and overlaying an outer portion of said base surface; and
wherein said first and second flanged edges of said at least one bracket each comprise a central stem and two oppositely disposed outwardly extending flanges; and wherein said at least one bracket further comprises first and second threaded fasteners respectively associated with said first and second flanged edges wherein after insertion of said first and second flanged edges in a respective one of said T-shaped grooves, each of said first and second fasteners is biasingly coupleable with a respective one of said base surfaces to thereby bias said outwardly extending flanges into engagement with said overlaying lips.

3. The modular structural system of claim 1 wherein said plurality of elongate structural members are formed by pultrusion.

4. The modular structural system of claim 1 further comprising a fitting having a substantially cylindrical socket adapted to securely engage a radially outer surface formed by the circular outer perimeter of the common cross sectional configuration of one of said plurality of elongate structural members.

5. The modular structural system of claim 1 wherein said reinforcement member is removeably insertable into said central opening.

6. A modular trellis system adapted for use with trellis wires, said system comprising:
a plurality of elongate structural members, each of said plurality of members being formed of a fiber-reinforced polymeric material and defining a substantially common cross sectional configuration, said common cross sectional configuration having a substantially circular outer perimeter interrupted by first and second oppositely disposed substantially T-shaped grooves;
at least one bracket member having first and second flanged edges disposed at an angle wherein said first flanged edge is securably engageable with one of said T-shaped grooves disposed on a first one of said plurality of elongate structural members and said second flanged edge is securably engageable with another one of said T-shaped grooves disposed on a second one of said plurality of elongate structural members whereby said first and second elongate structural members are securable together at an angle; and
at least one wire stay securably engageable with one of said T-shaped grooves at a selected position along said T-shaped groove and wherein the trellis wires are releasably graspable by said wire stay.

7. The modular trellis system of claim 6 wherein each of said substantially T-shaped grooves is defined by a base surface and oppositely disposed lips spaced from and overlaying an outer portion of said base surface; and
wherein said first and second flanged edges of said at least one bracket each comprise a central stem and two oppositely disposed outwardly extending flanges; and wherein said at least one bracket further comprises first and second threaded fasteners respectively associated with said first and second flanged edges wherein after insertion of said first and second flanged edges in a respective one of said T-shaped grooves, each of said first and second fasteners is biasingly coupleable with a respective one of said base surfaces to thereby bias said outwardly extending flanges into engagement with said overlaying lips.

8. The modular trellis system of claim 6 wherein each of said substantially T-shaped grooves is defined by a base surface and oppositely disposed lips spaced from and overlaying an outer portion of said base surface; and
wherein said wire stay includes a base positionable within one of said T-shaped grooves and engageable with said overlaying lips;
a shaft projecting from said base and extending outwardly of said T-shaped groove when said base is positioned within said groove, said shaft having a slotted distal end with a central slot separating first and second distal end portions of said shaft, said central slot forming a distal opening on distal end of said shaft and first and second oppositely disposed side openings on said shaft wherein one of the trellis wires is positionable in said central slot by passing a midsection of the wire through said distal opening of said slot with the wire extending outwardly through said first and second side openings; and
a retaining member securable on said shaft wherein said retaining member prevents the removal of a wire from said central slot through said distal opening when said retaining member is secured on said shaft.

9. The modular trellis system of claim 8 wherein said shaft has an outer threaded surface, said first and second side openings extending through said threaded surface and said retaining member having an inward facing threaded surface for securably engaging said outer threaded surface; and wherein at least one of said first and second distal end portions of said shaft has a spacing element disposed thereon and positioned to limit the radially inward displacement of said first and second distal end portions.

10. The modular trellis system of claim 6 wherein said substantially common cross sectional configuration includes a central opening disposed between said first and second substantially T-shaped grooves and wherein said system further comprises:
a reinforcement member removeably insertable into said central opening of said plurality of elongate structural members; and
at least one end cap removeably attachable to a distal end of one of said plurality of elongate structural members when said reinforcement member is positioned within said central opening of one of said plurality of elongate structural members.

11. The modular trellis system of claim 6 wherein said plurality of elongate structural members are formed by pultrusion.

12. The modular trellis system of claim 6 further comprising a fitting having a substantially cylindrical socket adapted to securely engage a radially outer surface formed by the circular outer perimeter of the common cross sectional configuration of one of said plurality of elongate structural members.

13. The modular trellis system of claim 6 wherein each of said substantially T-shaped grooves is defined by a base surface and oppositely disposed lips spaced from and overlaying an outer portion of said base surface; and said system further comprises:
a thin flexible sheet material; and
a flexible retention strip positionable within one of said T-shaped grooves wherein said flexible sheet material is positionable between said retention member and said base surface and overlaying lips when said retention strip is positioned within said T-shaped groove whereby said sheet material is securable to one of said plurality of elongate structural members by said retention strip.

14. The modular trellis system of claim 13 wherein said sheet material comprises a thermal insulating material.

15. The modular trellis system of claim 13 wherein said sheet material comprises a screen material.

16. The modular trellis system of claim 6 wherein said system comprises a first elongate structural member installable in a substantially vertical orientation, a second elongate structural member securable to said first structural member with said at least one bracket member in a substantially horizontal orientation and a third elongate structural member pivotally secured to said second structural member with a pivot bracket assembly;
said pivot bracket assembly including:
a first pivot member pivotally securing said pivot bracket to said second structural member proximate an end of said second structural member and thereby defining a first pivot axis;
a second pivot member pivotally securing said pivot bracket to said third structural member at a location spaced from and intermediate opposing first and second ends of said third structural member thereby defining a second pivot axis; said first and second pivot axes being substantially parallel and spaced apart wherein pivotal movement of said pivot bracket about said first pivot axis pivots said second pivot axis about said first pivot axis; and
pivotal movement of said pivot bracket and said third structural member about said first and second pivot axes repositions said third structural member between a first orientation wherein said first end of said third structural member is positioned below said second structural member and proximate said first structural member and said second end of said third structural member projects upwardly of said second structural member and a second orientation wherein said third structural member is positioned substantially parallel with and proximate said second structural member.

17. A modular trellis system adapted for use with trellis wires, said system comprising:
a plurality of elongate structural members each of said plurality of members being formed by a fiber-reinforced polymeric material and defining a substantially common cross sectional configuration, said common cross sectional configuration having at least one substantially T-shaped groove defined by a base surface and oppositely disposed lips spaced from and overlaying an outer portion of said base surface;
at least one wire stay, said wire stay including a base positionable within one of said T-shaped grooves and engageable with said overlaying lips;
a shaft projecting from said base and extending outwardly of said T-shaped groove when said base is positioned within said groove, said shaft having a distal end defining a wire slot, said slot forming an opening wherein one of the trellis wires is positionable in said slot by passing a midsection of the wire through said opening of said slot; and
a retaining member securable on said shaft wherein said retaining member prevents the removal of a wire from said slot through said opening when said retaining member is secured on said shaft.

18. The modular trellis system of claim 17 wherein said shaft has an outer threaded surface and said retaining member has an inward facing threaded surface for securably engaging said outer threaded surface.

19. A trellis system comprising:
a plurality of pivotal trellis assemblies, each of assemblies comprising a first elongate structural member installable in a substantially vertical orientation; a second elongate structural member securable to said first structural member in a substantially horizontal orientation and a third elongate structural member pivotally secured to said second structural member with a pivot bracket assembly;
said pivot bracket assembly including:
a first pivot member pivotally securing said pivot bracket to said second structural member proximate an end of said second structural member and thereby defining a first pivot axis;
a second pivot member pivotally securing said pivot bracket to said third structural member at a location spaced from and intermediate opposing first and second ends of said third structural member thereby defining a second pivot axis; said first and second pivot axes being substantially parallel and spaced apart wherein pivotal movement of said pivot bracket about said first pivot axis pivots said second pivot axis about said first pivot axis; and
pivotal movement of said pivot bracket and said third structural member about said first and second pivot axes repositions said third structural member between a first orientation wherein said first end of said third structural member is positioned below said second structural member and proximate said first structural member and said second end of said third structural member projects upwardly of said second structural member and a second orientation wherein said third structural member is positioned substantially parallel with and proximate said second structural member.

20. The trellis system of claim 19 wherein each of said elongate structural members is formed of a fiber-reinforced polymeric material and defines a substantially common cross sectional configuration, said common cross sectional configuration having at least one substantially T-shaped groove defined by a base surface and oppositely disposed lips spaced from and overlaying an outer portion of said base surface;
at least one trellis wire extending between adjacent ones of said plurality of pivotal trellis assemblies;
at least one wire stay secured to each of said third structural members and supporting said at least one trellis wire, said wire stays each including a base positionable within one of said T-shaped grooves and engageable with said overlaying lips, a shaft projecting from said base and extending outwardly of said T-shaped groove when said base is positioned within said groove, said shaft having a distal end defining a wire slot, said slot forming an opening wherein said trellis wire is positionable in said slot by passing a midsection of the wire through said opening of said slot; and
a retaining member securable on said shaft wherein said retaining member prevents the removal of said trellis wire from said slot through said opening when said retaining member is secured on said shaft.
